(19) United States
(12) Patent Application Publication
(10) Pub. No.: US 2014/0053783 A1
(43) Pub. Date: Feb. 27, 2014

(54) LITTER MAT

(71) Applicants: Theodore Elliott, West Orange, NJ (US); Andrew Roost, Fanwood, NJ (US)

(72) Inventors: Theodore Elliott, West Orange, NJ (US); Andrew Roost, Fanwood, NJ (US)

(73) Assignee: PET FUSION, LLC, West Orange, NJ (US)

(21) Appl. No.: 13/607,083

(22) Filed: Sep. 7, 2012

Related U.S. Application Data
(63) Continuation-in-part of application No. 29/430,416, filed on Aug. 24, 2012, now Pat. No. D688838.

(51) Int. Cl. A01K 29/00

(52) U.S. Cl. 119/161

(57) ABSTRACT

One embodiment of a litter mat comprises a first surface for receiving a litter box, a second surface opposite the first surface, a plurality of protrusions extending from the first surface and defining a plurality of recesses therebetween, and a channel formed into the first surface, the channel and the plurality of recesses for capturing litter tracked from a litter box.

### CROSS-REFERENCE TO RELATED APPLICATIONS

This is a continuation-in-part of U.S. application Ser. No. 29/430,416, filed Aug. 24, 2012, the contents of which are incorporated herein by reference.

### FIELD OF THE INVENTION

The present application relates to litter mats in general, and more particularly to a litter mat having a unique configuration for capturing and retaining litter and for preventing the tracking of litter after a cat has used the litter box.

### SUMMARY

One embodiment of a litter mat comprises a first surface for receiving a litter box, a second surface opposite the first surface, a plurality of protrusions extending from the first surface and defining a plurality of recesses therebetween, and a channel formed into the first surface, the channel and the plurality of recesses for capturing litter tracked from a litter box.

### BRIEF DESCRIPTION OF THE DRAWINGS

FIG. 1 illustrates one embodiment of a litter mat of the present disclosure in use supporting a litter box;

FIG. 2 is a top plan view of one embodiment of a litter mat of the present disclosure;

FIG. 3 is a left side view thereof, the right side view being identical;

FIG. 4 is a front edge view thereof, the rear edge view being identical;

FIG. 5 is a close up view of the box labeled “5” in FIG. 2;

FIG. 6 is a cross-section taken along line 6-6 in FIG. 5; and

FIG. 7 is a top diagrammatic view of one embodiment of a litter mat of the present disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

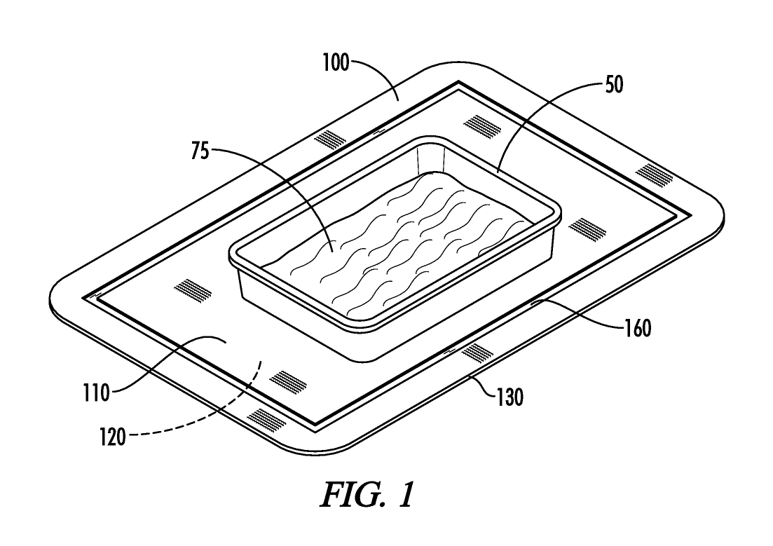

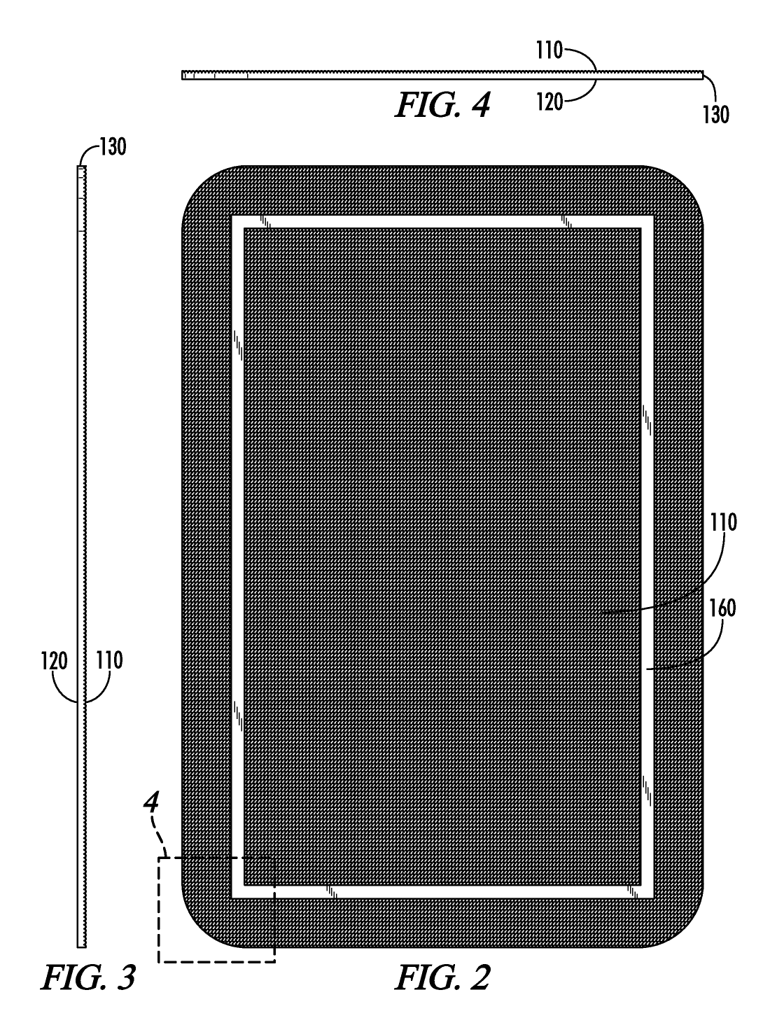

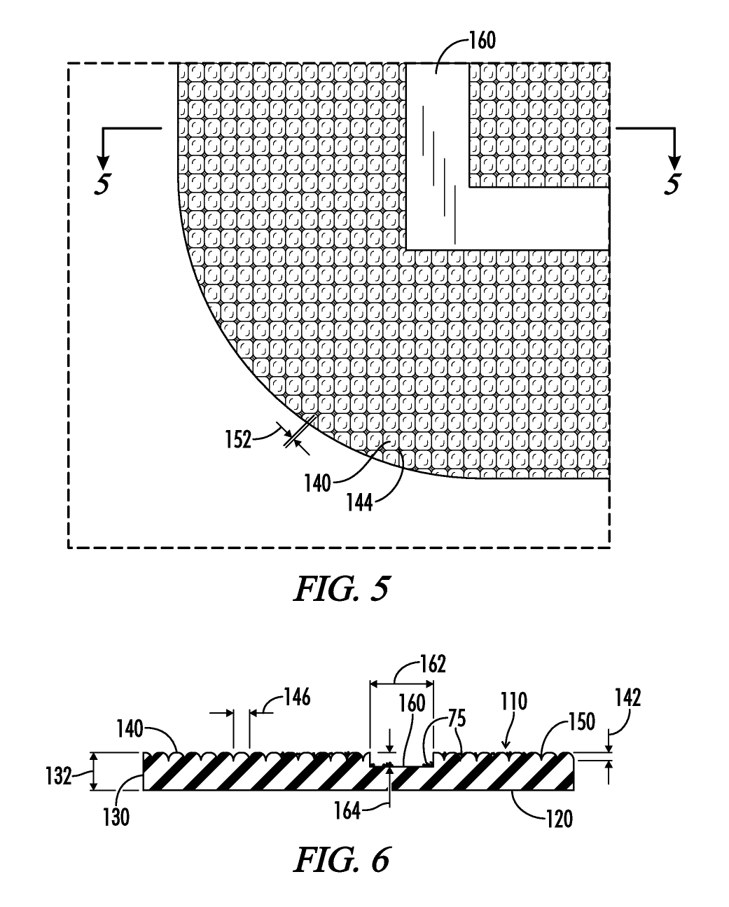

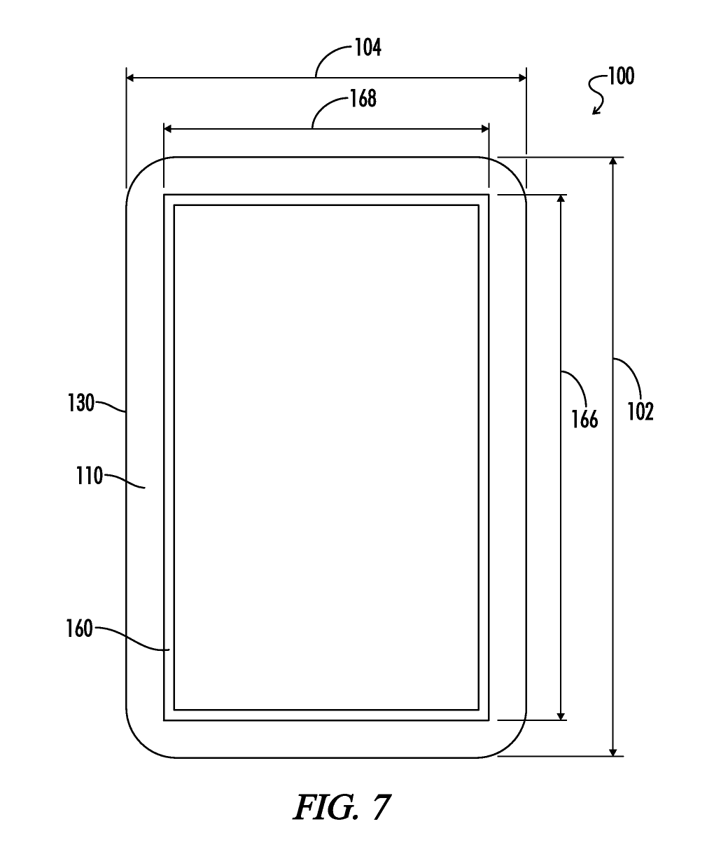

FIG. 1 illustrates one embodiment of a litter mat 100 of the present disclosure shown for purposes of illustration with a litter box 50 positioned thereon. The size, shape, material, cross-sectional configuration and structural properties of the litter mat 100 described herein are not meant to be limiting, but are described herein as one possible variation, it being understood that other configurations are possible. Furthermore, while the term “mat” is used herein, it will be appreciated that such term is not meant to be limiting in any respects. The embodiment of the litter mat 100 of FIG. 1 is shown in detail in FIGS. 2-6, where FIG. 2 is a top plan view of the embodiment of the litter mat 100 of FIG. 1, FIG. 3 is a left side view of the embodiment of the litter mat 100 of FIG. 1, the right side view being identical, FIG. 4 is a front edge view of the embodiment of the litter mat 100 of FIG. 1, the rear edge view being identical, FIG. 5 is a close up view of the box labeled “5” in FIG. 2, and FIG. 6 is a cross-section taken along line 6-6 in FIG. 5. FIG. 7 is a diagrammatic view of the embodiment of the litter mat 100 of FIG. 1 for purposes of illustrating structural features and dimensions.

The litter mat 100 further comprises a first surface 110 for receiving a litter box 50 (FIG. 1), a second surface 120 opposite the first surface 110 for contacting or resting upon a support (not shown) such as a floor or the ground, and an outer edge 130 having a thickness 132 defined between the first and second surfaces 110, 120. A plurality of protrusions 140 extend upwardly from the first surface 110 and define a plurality of indentations or recesses 150 therebetween, the protrusions 140 and recesses 150 forming a continuous surface. Each protrusion 140 preferably comprises a protrusion height 142 and a square configuration with slightly rounded corners 144. In one embodiment, the protrusion height 142 is approximately 0.0625 inches (+/−0.03125 inches), although other dimensions are possible, and the square configuration is defined by a diameter 146 of approximately 0.125 inches (+/−0.0625 inches), although other dimensions are possible. Each recess 150 is bordered by the slightly rounded corners 144 of adjacently positioned protrusions 140, with each recess 150 having a diameter 152 of approximately 0.03125 inches (+/−0.015625 inches), although other dimensions are possible.

The litter mat 100 preferably further comprises a channel 160 formed into the first surface 100, the channel 160 having a width 162 (FIG. 6) of approximately 0.75 inches (+/−0.03125 inches), although other dimensions are possible, and a depth 164 (FIG. 6) of approximately 0.125 inches, although other dimensions are possible. The channel 160 is preferably centered on the first surface 110 and is positioned in close proximity to the outer edge 130, with protrusions 140 bordering either side of the channel 160 and extending to the outer edge 130 of the mat 100. The plurality of recesses 150 and the channel 160 are configured for capturing litter 75 (FIG. 6) tracked from a litter box 50 (FIG. 1). The protrusions 140 frictionally engage and loosen and/or remove litter 75 tracked from a cat's paws (not shown), which litter 75 is then captured in the recesses 150 and/or channel 160 for later sweeping or vacuuming. The protrusions 140 are preferably formed from a material 148 that is sufficiently gripping and preferably compressible to create frictional engagement with a litter box 50 situated thereon, and with cat's paws to capture and retain litter 75, and to prevent the captured and retained litter 75 from being tracked away from the mat 100. In one embodiment, the material is a polymer such as polyvinyl chloride (PVC), with a preferred density of approximately 1250 grams per square meter (+/−40 grams per square meter), although other materials are possible.

In a preferred embodiment, the same material is used to form the entirety of the mat 100, including the first and second surfaces 110, 120, the protrusions 140 and the channel 160. Forming the mat 100 from a single material aids in manufacturing, although other materials or combinations of materials may be used. The material should also be easy to clean by sweeping, vacuuming and washing, especially since most tracked litter is laden with urine or fecal matter, or in the event the cat misses the box altogether. The channel 160 also functions as a moat that is depressed into the first surface 110 of the mat 100 and that catches litter 75 that bounces, is spread or is dragged across the first surface 110 of the mat 100. The channel 160 is preferably deeper than a recess 150 as shown in FIG. 6 so as to create a depression or a floor for retaining litter 75. The channel 160 could also function to retain urine or other undesirable substances from escaping or leaking away from the mat 100.

Returning now to FIG. 7, there is shown one particular embodiment of a litter mat 100 as described in connection with FIGS. 1-6, it being understood that the litter mat 100 can assume any size, shape, material, cross-sectional configuration and structural property. For example, FIG. 7 illustrates a litter mat 100 having a partially rounded outer edge configuration 130 having a length 102 of approximately 36 inches and a width 104 of approximately 24 inches. The channel 160 has a generally rectangular configuration with an overall length 166 of approximately 30 inches and an overall width 168 of approximately 20 inches, the channel 160 preferably being centered on the first surface 110. The rectangular configuration of the channel 160 also serves as a guide for centering a litter box 50 (FIG. 1) on the mat 100, since litter boxes also tend to be rectangular in configuration.

In the mat embodiment of FIGS. 1-7, the second surface 120 is not shown with the same level of detail as the first surface 110. In one embodiment, the second surface 120 may be flat and may not have any protrusions or recesses or the like. In another embodiment, the second surface 120 may be similar in structural configuration to the first surface 110, so that the mat 100 may be reversible, which may be preferable if the first surface incorporates a first aesthetic design suitable for one decor while the second surface incorporates a second aesthetic design suitable for a different decor. For example, one side might be male-oriented and one side might be female-oriented, or one side might be modern or contemporary in design and one side might be country in design. In another embodiment, the first and second surfaces are identically configured. In another embodiment, the second surface might have a different configuration of protrusions and recesses and may or may not be provided with a channel, as compared with the first surface. In one embodiment (not shown), the first surface may only be provided with protrusions and recesses and not have a channel. In one embodiment, the protrusions and recesses may be provided with different structural configurations, and the channel may also be provided with a different structural placement other than shown in the embodiment of FIGS. 1-7.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A litter mat comprising:
a) a first surface for receiving a litter box, a second surface opposite the first surface, and an outer edge having a thickness defined between the first and second surfaces;
b) a plurality of protrusions extending from the first surface and defining a plurality of recesses therebetween; and
c) a channel formed into the first surface, the channel and the plurality of recesses for capturing litter tracked from a litter box.

2. The litter mat of claim 1, wherein the first and second surfaces are formed from the same material.

3. The litter mat of claim 2, wherein the plurality of protrusions and the channel are formed from the same material as the first and second surfaces.

4. The litter mat of claim 3, wherein the material is a polymer.

5. The litter mat of claim 4, wherein the material is polyvinyl chloride (PVC).

6. The litter mat of claim 5, wherein the material is compressible.

7. The litter mat of claim 6, wherein the material has a density of approximately 1250 grams per square meter.

8. The litter mat of claim 1, wherein the channel has a depth into the first surface of approximately one-half the thickness of the outer edge.

9. The litter mat of claim 1, wherein the channel is centered on the first surface.

10. The litter mat of claim 9, wherein the channel is substantially adjacent the outer edge.

11. The litter mat of claim 1, wherein the outer edge is partially rounded and the channel is rectangular.

12. The litter mat of claim 1, wherein each protrusion has a square configuration with slightly rounded corners.

13. The litter mat of claim 12, wherein each protrusion has a height of approximately 0.0625 inches

14. The litter mat of claim 13, wherein each protrusion has a diameter of approximately 0.125 inches.

15. The litter mat of claim 14, wherein each recess has a diameter of approximately 0.03125 inches.

16. The litter mat of claim 1, wherein the first surface is suitable for one decor and the second surface is suitable for a different decor.

17. The litter mat of claim 16, wherein the decor is related to color or style.

18. The litter mat of claim 1, wherein the first and second surfaces are identically configured.
